(19) United States
(12) Patent Application Publication
(10) Pub. No.: US 2026/0118698 A1
(43) Pub. Date: Apr. 30, 2026

(54) HINGE MODULE AND SMART GLASSES

(71) Applicant: GOERTEK INC., Weifang (CN)

(72) Inventors: Xiongchun DU, Weifang (CN); Yaocheng LIU, Weifang (CN); Qingkao WU, Weifang (CN); Chao ZHANG, Weifang (CN); Xiangdong LAN, Weifang (CN); Chuanlong LI, Weifang (CN)

(21) Appl. No.: 19/433,586

(22) Filed: Dec. 26, 2025

Related U.S. Application Data
(63) Continuation of application No. PCT/CN2024/137138, filed on Dec. 5, 2024.

(30) Foreign Application Priority Data
Jun. 26, 2024 (CN) 202410844229.7

(51) Int. Cl. G02C 5/22; G02B 27/01

(52) U.S. Cl. CPC G02C 5/2236; G02B 27/0149; G02B 27/0176; G02C 5/2254; G02B 2027/0154; G02B 2027/0178

(57) ABSTRACT

The present application provides a hinge module and smart glasses. The hinge module includes a first connecting member, a second connecting member, and a first elastic member. The second connecting member is rotatably connected to the first connecting member via a rotating shaft. The second connecting member has an open state; in the open state, the second connecting member can rotate and fold in a first direction and rotate and fold outward in a second direction opposite to the first direction. The first elastic member is configured to apply a damping elastic force to the rotating and outward-folding second connecting member, and the direction of the elastic force of the first elastic member intersects the axial direction of the rotating shaft.

### CROSS-REFERENCE TO RELATED APPLICATIONS

The present application is a continuation application of International Application No. PCT/CN2024/137138, filed on Dec. 5, 2024, which claims priority to Chinese Patent Application No. 202410844229.7, entitled in “HINGE MODULE AND SMART GLASSES” and filed on Jun. 26, 2024. The disclosures of the above-mentioned applications are incorporated herein by reference in their entireties.

### TECHNICAL FIELD

The present application relates to the technical field of head-mounted display, and in particular to a hinge module and smart glasses using the hinge module.

### BACKGROUND

Currently, the frames and temples of smart glasses are typically connected by hinge modules to allow the temples to open and fold. However, these smart glasses rely primarily on the deformation of the temples themselves to accommodate users with different head sizes. Since the deformation of the temples is relatively small, their applicability to users with different head sizes is limited. Furthermore, this can easily result in glasses that are too loose or too tight, affecting wearing comfort.

### SUMMARY

The main objective of the present application is to provide a hinge module designed to improve the adaptability of smart glasses to users with different head sizes, while also enhancing wearing comfort.

To achieve the above objective, the hinge module proposed in the present application includes:

a first connecting member;

a second connecting member rotatably connected to the first connecting member via a rotating shaft; the second connecting member has an open state, and the second connecting member in the open state is capable of rotating and folding in a first direction and rotating and folding outward in a second direction opposite to the first direction; and

a first elastic member configured to apply a damping elastic force to the rotating and outward-folding second connecting member, and a direction of the elastic force of the first elastic member intersects an axial direction of the rotating shaft.

In an embodiment, the first elastic member is provided at the first connecting member, and the hinge module further includes a sliding member; the sliding member is slidably connected to the first connecting member, and the rotating and outward-folding second connecting member is capable of abutting and driving the sliding member to press against the first elastic member.

In an embodiment, the sliding member includes:

a sliding rod slidably connected to the first connecting member, and the rotating and outward-folding second connecting member being capable of abutting and driving the sliding rod; and

a driving plate connected to the sliding rod and abutted against the first elastic member.

In an embodiment, the first connecting member is provided with a mounting groove and a through hole communicating with the mounting groove, and the first elastic member is provided within the mounting groove; the sliding rod passes through the through hole, and the driving plate is provided within the mounting groove.

In an embodiment, the first elastic member and the driving plate are sleeved on the sliding rod located within the mounting groove; and/or

the first connecting member is further provided with a mounting opening communicating with the through hole and an outer surface of the first connecting member.

In an embodiment, the sliding member further includes an abutting plate connected to the sliding rod and located on a side of the driving plate opposite to the first elastic member, and the rotating and outward-folding second connecting member is abutted against and drives the abutting plate.

In an embodiment, the second connecting member is provided with a driving surface, and the abutting plate is provided with an abutting surface on a side opposite to the driving plate; the rotating and outward-folding second connecting member is abutted against the abutting surface through the driving surface, and both the driving surface and the abutting surface include an outwardly convex arc surface; and/or

the abutting plate extends along the axial direction of the rotating shaft, and a number of the sliding rod, the driving plate, and the first elastic member is at least two respectively; at least two of the sliding rods are connected to the abutting plate and are arranged sequentially along the axial direction of the rotating shaft; each driving plate is connected to one sliding rod, and each first elastic member is abutted against one driving plate.

In an embodiment, the first connecting member is provided with a first connecting ear, and the second connecting member is provided with a second connecting ear; the second connecting ear and the first connecting ear is arranged opposite to each other; and

the hinge module further includes a rotating shaft and a second elastic member, and the rotating shaft passes through the first connecting ear and the second connecting ear; the second elastic member is sleeved on the rotating shaft and elastically abutted against the first connecting ear and the second connecting ear.

In an embodiment, a number of the first connecting ear, the second connecting ear, the rotating shaft, and the second elastic member are all two; the two first connecting ears are spaced apart in the axial direction of the rotating shaft, and a wire passage is formed between the two first connecting ears; and

each second connecting ear corresponds to one first connecting ear and is located outside the wire passage; each rotating shaft passes through one second connecting ear and one first connecting ear, and each second elastic member is sleeved on one rotating shaft.

The present application further provides smart glasses, including: a frame, temples, and the hinge module; a first connecting member in the hinge module is connected to the frame, and a second connecting member in the hinge module is connected to the temples.

In an embodiment, the smart glasses further include a shaft cover, and the shaft cover is circular in projection along the axial direction of the rotating shaft; and

the shaft cover, the frame, and the temples are enclosed to form an accommodating space, and the hinge module is located within the accommodating space.

In an embodiment, the shaft cover includes:

two end plates located on opposite sides of the hinge module in the axial direction of the rotating shaft and coaxially arranged with the rotating shaft; and

a connecting plate, opposite ends of the connecting plate being connected to the two end plates;

at least one end plate and/or the connecting plate is provided with two first limiting ribs on an inner side, and the two first limiting ribs are spaced apart circumferentially along the end plate; the second connecting member is provided with a second limiting rib, and the second limiting rib is located between the two first limiting ribs.

In the technical solution of the present application, the hinge module configures the second connecting member, which is in the open state, to be able to rotate and fold in a first direction and rotate and fold outward in a second direction opposite to the first direction. This allows the temples connected to the second connecting member to not only fold but also have an outward folding space in the second direction, making them more suitable for users with larger heads. Furthermore, when the user folds the temples outward, the first elastic member applies a damping elastic force to the moving second connecting member, causing the temples to clamp to fit the user's head and maintain wearing stability. After the glasses are removed, the first elastic member returns to its original position, causing the temples to automatically return to the open state. Therefore, the hinge module structure in this solution is suitable for users with different head sizes and allows for adjustment of the clamping force to regulate the tightness of the fit based on the user's head size. This improves the applicability of the smart glasses to users with different head sizes and enhances wearing comfort. Moreover, the elastic force direction of the first elastic member in the hinge module of this solution intersects with the axial direction of the rotating shaft. At this point, on the one hand, it facilitates the compression and compact arrangement of the first elastic member when the second connecting member is folded outward, thereby improving the convenience of manufacturing the hinge module and reducing its overall size, thus enhancing the ease of installation within a limited space. On the other hand, it also increases the utilization efficiency of the elastic force of the first elastic member, thereby increasing its damping effect on the folded second connecting member. This provides greater adjustment space when adjusting the clamping force according to the user's head size, further improving the applicability and wearing comfort for users with different head sizes.

### BRIEF DESCRIPTION OF THE DRAWINGS

In order to more clearly illustrate the technical solutions in the embodiments of the present application or the related art, the drawings required for use in the embodiments or the related art description will be briefly introduced below. Obviously, the drawings described below are only some embodiments of the present application; for those skilled in the art, other drawings can be obtained based on the structures shown in these drawings without creative labor.

FIG. 1 is a partial structural schematic diagram of smart glasses according to an embodiment of the present application.

FIG. 2 is an exploded structural schematic diagram of the smart glasses in FIG. 1.

FIG. 3 is another perspective schematic diagram of the smart glasses in FIG. 2.

FIG. 4 is a structural schematic diagram of the hinge module in FIG. 1.

FIG. 5 is another perspective schematic diagram of the hinge module in FIG. 4.

FIG. 6 is an exploded structural schematic diagram of the hinge module in FIG. 5.

FIG. 7 is a schematic diagram of the second connecting member of the hinge module in FIG. 1 in an open state.

FIG. 8 is a schematic diagram of the second connecting member of the hinge module in FIG. 7 in a folded state.

FIG. 9 is a schematic diagram of the second connecting member of the hinge module in FIG. 7 in an outward-folding state.

The realization of the purpose, functional features and advantages of the present application will be further explained in conjunction with the embodiments and with reference to the accompanying drawings.

### DETAILED DESCRIPTION OF THE EMBODIMENTS

The technical solutions of the embodiments of the present application will be clearly and completely described below with reference to the accompanying drawings. Obviously, the described embodiments are only a part of the embodiments of the present application, not all of them. All other embodiments obtained by those skilled in the art based on the embodiments of the present application without creative effort are within the scope of protection of the present application.

It should be noted that all directional indications (such as up, down, left, right, front, back, etc.) in the embodiments of the present application are only used to explain the relative positional relationship and movement of the components in a specific posture (as shown in the accompanying drawings). If the specific posture changes, the directional indication will also change accordingly.

In the present application, unless otherwise explicitly specified and limited, the terms “connection”, “fixation” etc., should be interpreted broadly. For example, “fixation” can mean a fixed connection, a detachable connection, or an integral part; it can mean a mechanical connection or an electrical connection; it can mean a direct connection or an indirect connection through an intermediate medium; it can mean the internal communication of two components or the interaction between two components, unless otherwise explicitly limited. Those skilled in the art can understand the specific meaning of the above terms in the present application according to the specific circumstances.

Furthermore, the use of terms such as “first” and “second” in the present application is for descriptive purposes only and should not be construed as indicating or implying their relative importance or implicitly specifying the number of technical features indicated. Therefore, a feature defined with “first” or “second” may explicitly or implicitly include at least one of those features. Additionally, the word “and/or” throughout the text means including three parallel solutions; for example, “A and/or B” includes solution A, solution B, or a solution that simultaneously satisfies A and B. Furthermore, the technical solutions of the various embodiments can be combined with each other, but this must be based on the ability of those skilled in the art to implement them. When the combination of technical solutions is contradictory or impossible to implement, it should be considered that such a combination of technical solutions does not exist and is not within the scope of protection claimed in the present application.

The present application proposes a hinge module that can be used to realize a rotational connection between two components. The following mainly uses the application of the hinge module in smart glasses as an example for explanation. It is understood that the hinge module can also be applied to other products that need to realize folding and outward-folding functions.

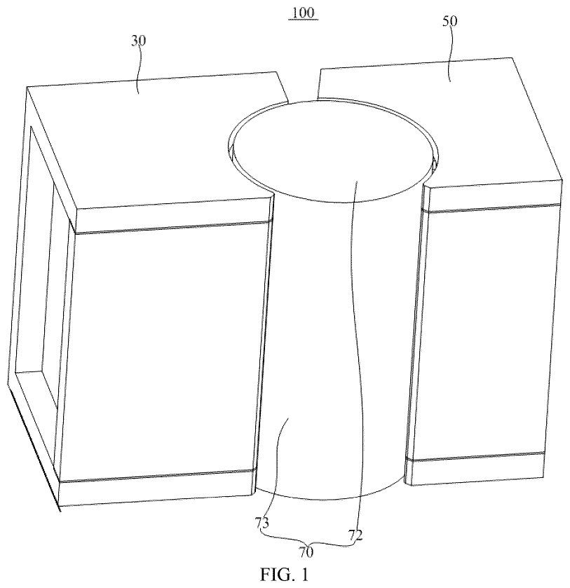

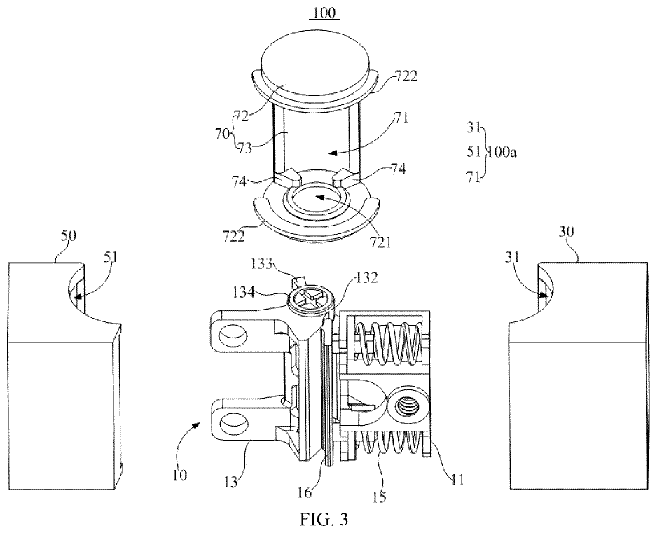

Referring to FIGS. 1 to 4 and FIGS. 7 to 9, in an embodiment of the present application, the hinge module 10 includes a first connecting member 11, a second connecting member 13, and a first elastic member 15. The second connecting member 13 is rotatably connected to the first connecting member 11 via a rotating shaft 17. The second connecting member 13 has an open state, allowing it to fold in a first direction and fold outwards in a second direction opposite to the first direction. The first elastic member 15 is configured to apply a damping elastic force to the rotating and outward-folding second connecting member 13, and the direction of the elastic force of the first elastic member 15 intersects the axial direction of the rotating shaft 17.

The first connecting member 11 can be connected at one end to the frame 30 and at the other end to the second connecting member 13 for rotatable connection. The first connecting member 11 and the frame 30 can be connected by a thread to improve the convenience and stability of the connection. This threaded connection includes a screw connection and a combination of bolts and nuts. Of course, the first connecting member 11 and the frame 30 can also be connected by snap-fit or magnetic connection, etc. The present application does not limit the connection method between the first connecting member 11 and the frame 30. Furthermore, the first connecting member 11 can be a plate structure (including a single plate and a combination of at least two plates), or it can be a column structure or a base structure, etc. The present application does not limit the structural type and shape of the first connecting member 11.

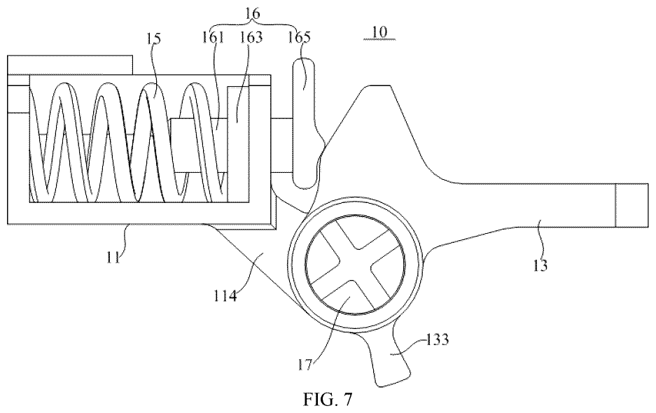

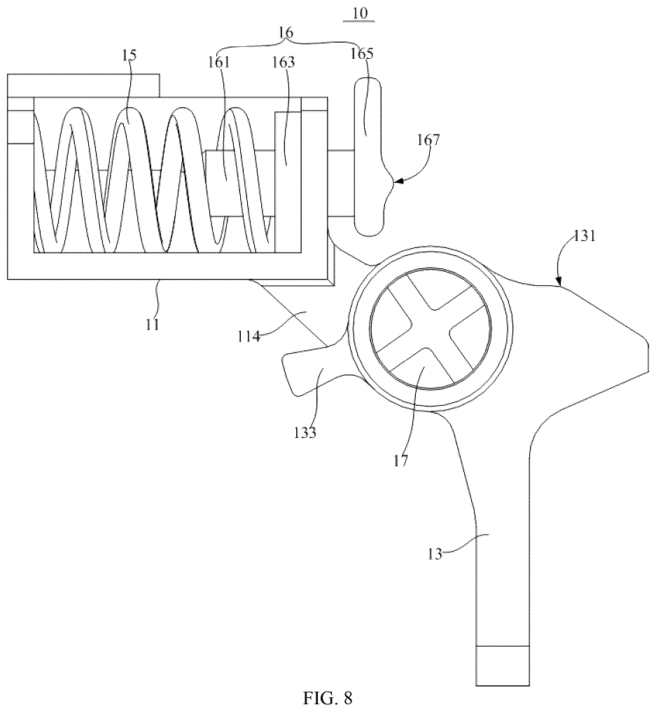

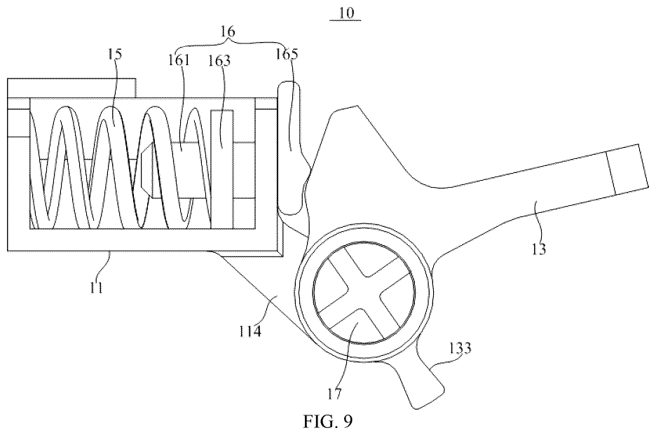

The second connecting member 13 can be connected at one end to the temple 50, and at the other end to the first connecting member 11 for rotatable connection. The second connecting member 13 and the temple 50 can be connected by threads to improve the convenience and stability of the connection. Of course, the second connecting member 13 and the temple 50 can also be connected by snap-fit or magnetic connection, etc. The present application does not limit the connection method between the second connecting member 13 and the temple 50. Additionally, the second connecting member 13 and the first connecting member 11 can be rotatably connected by a rotating shaft 17, as described below. Of course, either the second connecting member 13 or the first connecting member 11 may have a rotating shaft 17, and the other may have a insertion hole, with the rotating shaft 17 inserted into the insertion hole for rotational connection. Therefore, the present application does not limit the rotational connection structure between the first connecting member 11 and the second connecting member 13. Furthermore, the second connecting member 13 can be a plate structure (including a single plate and a combination of at least two plates), or it can be a column structure or a base structure, etc. The present application does not limit the structural type and shape of the second connecting member 13. Additionally, it should be noted that the second connecting member 13 is in the open state, as shown in FIG. 7, that is, when the temple 50 forms a 90° or approximately 90° angle with the frame 30. At this time, the second connecting member 13 rotates in the first direction, or inwards, as shown in FIG. 8, allowing the temple 50 to fold into the frame 30. The second connecting member 13 rotates in the second direction, or outwards, as shown in FIG. 9, allowing the temple 50 to be further folded outwards for use by users with larger heads.

The first elastic member 15 applies a damping elastic force to the rotating and outward-folding second connecting member 13. When this damping elastic force is transmitted to the temple 50 through the second connecting member 13, it causes the temple 50 to clamp onto the user's head, thus creating a clamping force. When the axial direction of the rotating shaft 17 is vertical, the direction of the elastic force of the first elastic member 15 can be horizontal. The first elastic member 15 can be located on the first connecting member 11 as described below, or it can be located on the second connecting member 13, ensuring that it is compressed during the outward folding of the second connecting member 13. Furthermore, the first elastic member 15 can be a spring to provide relatively good elasticity, while also facilitating market availability and subsequent installation. Of course, the first elastic member 15 can also be a spring sheet, etc., and the present application does not limit the structural type of the first elastic member 15.

The hinge module 10 of the present application configures the second connecting member 13, which is in the open state, to be able to rotate and fold in a first direction and rotate and fold outward in a second direction opposite to the first direction. This allows the temple 50 connected to the second connecting member 13 to not only fold but also have an outward folding space in the second direction, making it convenient for users with larger heads to wear. Furthermore, when the user folds the temple 50 outward, the first elastic member 15 can apply a damping elastic force to the moving second connecting member 13 to drive the temple 50 to fit the user's head and maintain wearing stability. After the glasses are removed, the first elastic member 15 can reset, causing the temple 50 to automatically return to the open state. Therefore, the structural design of the hinge module 10 in this solution allows for convenient wearing by users with different head sizes, and the clamping force can be adjusted according to the user's head size to regulate the tightness of the fit. This improves the applicability of the smart glasses 100 to users with different head sizes, while also enhancing wearing comfort. Furthermore, the elastic force direction of the first elastic member 15 in the hinge module 10 of the present application intersects with the axial direction of the rotating shaft 17. This facilitates the compression and compact arrangement of the first elastic member 15 when the second connecting member 13 is folded outwards, improving the manufacturing convenience of the hinge module 10 and reducing its overall size, thus enhancing the ease of installation within limited space. On the other hand, it also increases the utilization efficiency of the elastic force of the first elastic member 15, increasing its damping effect on the folded second connecting member 13. This provides greater adjustment space when adjusting the clamping force according to the user's head size, further improving applicability to users with different head sizes and wearing comfort.

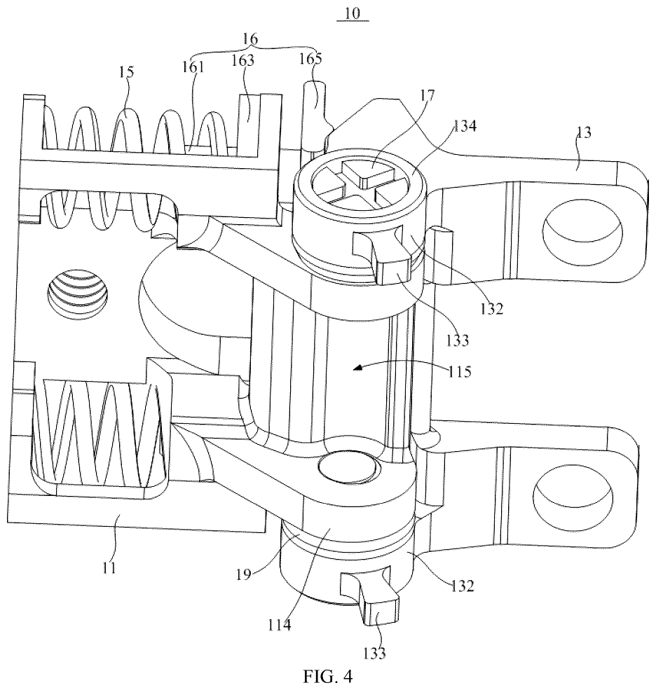

Referring to FIGS. 4 to 7, in an embodiment of the present application, a first elastic member 15 is provided at a first connecting member 11. The hinge module 10 also includes a sliding member 16, which is slidably connected to the first connecting member 11. A rotating, outward-folding second connecting member 13 can abut against and drive the sliding member 16 to press against the first elastic member 15.

The sliding member 16 is an object slidably mounted on the first connecting member 11. When the second connecting member 13 rotates outward, the sliding member 16 can be abutted against and driven by the second connecting member 13 to press against the first elastic member 15. The sliding member 16 can include, as described below, a sliding rod 161 and a driving plate 163. Of course, the sliding member 16 can also be a plate structure or a column structure, etc. The present application does not limit the structural type and shape of the sliding member 16. Furthermore, the first elastic member 15 and the second elastic member 19 can be provided at the outside of the first connecting member 11 to facilitate the outward-folding second connecting member 13 abutting against and driving the sliding member 16.

In this embodiment, the first elastic member 15 is provided at the first connecting member 11, which allows the first elastic member 15 to be fixedly provided, thereby improving the stability of the installation of the first elastic member 15 and the stability of its subsequent operation. Furthermore, the addition of a sliding member 16 facilitates the sequential engagement of the first elastic member 15, the sliding member 16, and the second connecting member 13, improving the stability of the transmission of the elastic force of the first elastic member 15.

Referring to FIGS. 4 to 7, in an embodiment of the present application, the sliding member 16 includes a sliding rod 161 and a driving plate 163. The sliding rod 161 is slidably connected to the first connecting member 11, and the outwardly rotated second connecting member 13 abuts against and drives the sliding rod 161. The driving plate 163 is connected to the sliding rod 161 and abuts against the first elastic member 15.

The sliding rod 161 can be slidably installed on the first connecting member 11 and can also be abutted and driven by the outwardly rotated second connecting member 13. The sliding rod 161 extends along the elastic direction of the first elastic member 15. The cross-section of the sliding rod 161 can be any shape, such as circular, square, or rectangular. The driving plate 163 abuts against the first elastic member 15, thereby compressing the first elastic member 15 when the sliding rod 161 is abutted and driven by the outwardly rotated second connecting member 13. The driving plate 163 can be any shape, such as square, rectangular, or circular.

In this embodiment, the sliding member 16 is configured to include the sliding rod 161 and the driving plate 163, allowing the sliding member 16 to slide and compress the first elastic member 15 through different components. This improves the ease of installation and arrangement of the first connecting member 11, the first elastic member 15, and the sliding member 16. Furthermore, using the driving plate 163 to abut and compress the first elastic member 15 facilitates the abutting and cooperation between the two, thus improving the stability of the compression of the first elastic member 15.

Referring to FIGS. 4 to 7, in an embodiment of the present application, the first connecting member 11 has a mounting groove 111 and a through hole 112 connecting the mounting groove 111. A first elastic member 15 is provided within the mounting groove 111; a sliding rod 161 passes through the through hole 112, and a driving plate 163 is provided within the mounting groove 111.

In this embodiment, by providing the mounting groove 111 and the through hole 112, the first elastic member 15 and the sliding member 16 can be conveniently positioned for installation. Furthermore, the structure of the mounting groove 111 and the through hole 112 is relatively simple, which improves the convenience and stability of installing the first elastic member 15 and the sliding member 16. In addition, it improves the compactness of the distribution of the first elastic member 15 and the sliding member 16 on the first connecting member 11, further reducing the overall volume of the hinge module 10.

Referring to FIGS. 4 to 7, in an embodiment of the present application, the first elastic member 15 and the driving plate 163 are sleeved on the sliding rod 161 located within the mounting groove 111.

In this embodiment, the driving plate 163 is sleeved onto the sliding rod 161 located within the mounting groove 111, allowing the end of the sliding rod 161 within the mounting groove 111 to be further inserted into the first elastic member 15. This sliding rod 161 further guides the direction of the elastic force of the first elastic member 15, ensuring that the first elastic member 15 accurately and stably applies damping elastic force to the outwardly folded second connecting member 13. Of course, in other embodiments, the driving plate 163 can also be directly connected to the end face of the sliding rod 161 within the mounting groove 111.

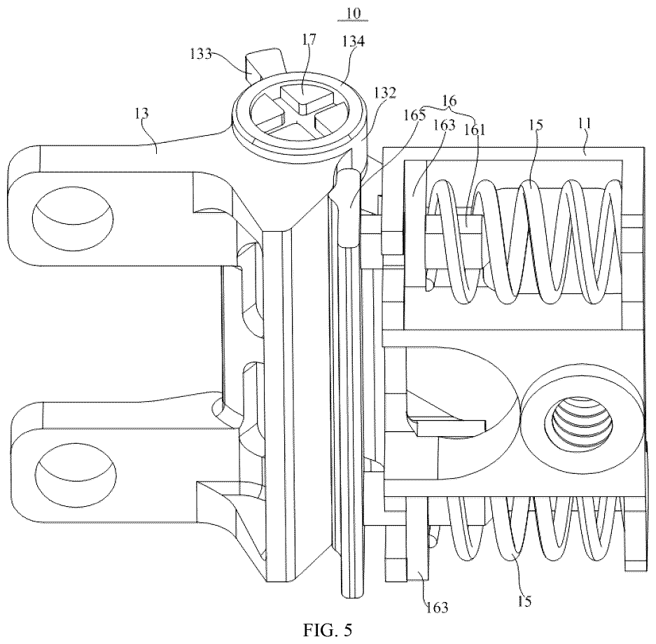

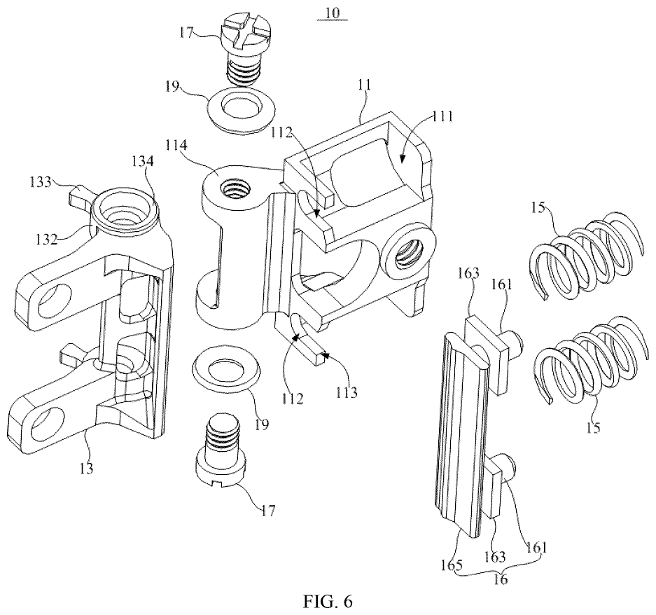

Referring to FIGS. 5 and 6, in an embodiment of the present application, the first connecting member 11 also provides a mounting opening 113 communicating a through hole 112 with the outer surface of the first connecting member 11.

In this embodiment, the mounting opening 113 can penetrate the outer surface of the first connecting member 11, so that when the first elastic member 15 is installed into the mounting groove 111 from the opening of the mounting groove 111, the sliding member 16 can be correspondingly installed into the through hole 112 from the mounting opening 113, thereby improving the convenience of installing the sliding member 16.

Referring to FIGS. 4 to 7, in an embodiment of the present application, the sliding member 16 further includes an abutting plate 165. The abutting plate 165 is connected to the sliding rod 161 and is located on the side of the driving plate 163 opposite to the first elastic member 15. The rotating and outward-folding second connecting member 13 can abut against and drive the abutting plate 165.

In this embodiment, the abutting plate 165 is connected to one end of the sliding rod 161 located outside the mounting groove 111, so that when the second connecting member 13 is folded outward, the second connecting member 13 can abut against and drive the abutting plate 165. At this time, the abutting plate 165 facilitates the abutting engagement with the second connecting member 13, thereby improving the stability of the outward-folding second connecting member 13 in abutting and driving the sliding member 16.

Referring to FIGS. 7 to 9, in an embodiment of the present application, the second connecting member 13 has a driving surface 131, and the abutting plate 165 has an abutting surface 167 on the side opposite to the driving plate 163. The outward-folding second connecting member 13 abuts against the abutting surface 167 via the driving surface 131. Both the driving surface 131 and the abutting surface 167 include outwardly convex arc surfaces.

In this embodiment, both the driving surface 131 and the abutting surface 167 are configured to include outwardly convex arc surfaces, so that when the second connecting member 13 is in the open position and the maximum outward-folding position, the abutting positions of the driving surface 131 and the abutting surface 167 are near the center of the sliding rod 161. This improves the sliding stability of the sliding rod 161, thereby ensuring that the torque exerted by the elastic force of the first elastic member 15 on the second connecting member 13 remains within a relatively stable range. That is, improving the stability of the clamping force of the temples 50 on the user's head further enhances wearing comfort.

Referring to FIGS. 5 and 6, in an embodiment of the present application, the abutting plate 165 extends along the axial direction of the rotating shaft 17. The number of sliding rods 161, driving plates 163, and first elastic members 15 are all at least two. At least two sliding rods 161 are connected to the abutting plate 165 and are arranged sequentially along the axial direction of the rotating shaft 17. Each driving plate 163 is connected to one sliding rod 161, and each first elastic member 15 abuts against one driving plate 163.

In this embodiment, by setting the number of sliding rods 161, driving plates 163, and first elastic members 15 to at least two, when the outward-folding second connecting member 13 abuts against and drives one abutting plate 165, at least two first elastic members 15 can be compressed by at least two driving plates 163, thereby increasing the damping elastic force applied to the outward-folding second connecting member 13. Furthermore, at this time, at least two first elastic members 15 can be simultaneously compressed, improving the uniformity and stability of the elastic force. Additionally, at least two mounting grooves 111 and through holes 112, as described above, can be correspondingly provided for the installation of the corresponding first elastic members 15 and sliding rods 161.

In an embodiment of the present application, the sliding rod 161, the driving plate 163, and the abutting plate 165 are an integral structure.

An integral structure means that it can be formed into a single unit after manufacturing. This can be achieved through injection molding, stamping, or casting.

In this embodiment, making the sliding rod 161, the driving plate 163, and the abutting plate 165 an integral structure can improve the production efficiency of the sliding member 16, while simultaneously enhancing the connection strength between the various components and thus improving the overall strength of the sliding member 16.

Referring to FIGS. 4 to 6, in an embodiment of the present application, the first connecting member 11 has a first connecting ear 114, and the second connecting member 13 has a second connecting ear 132, with the second connecting ear 132 and the first connecting ear 114 arranged opposite to each other. The hinge module 10 also includes a rotating shaft 17 and a second elastic member 19. The rotating shaft 17 passes through the first connecting ear 114 and the second connecting ear 132, and the second elastic member 19 is sleeved on the rotating shaft 17 and elastically abuts against the first connecting ear 114 and the second connecting ear 132 (that is, the second elastic member 19 is in a pre-compressed state; the second elastic member 19 can be a spring or a sheet, etc.).

In this embodiment, by passing the rotating shaft 17 through the first connecting ear 114 and the second connecting ear 132 to achieve the rotational connection between the first connecting member 11 and the second connecting member 13, the connection structure of the first connecting member 11 and the second connecting member 13 is relatively simple, thereby improving the convenience of connecting the first connecting member 11 and the second connecting member 13. Simultaneously, the rotating shaft 17 also provides a mounting position for the second elastic member 19, allowing the second elastic member 19 to provide a damping feel when the second connecting member 13 is folded or rotated from a folded position to an open position, further improving the user experience. The rotating shaft 17 can be in the form of a pin or a screw.

Referring to FIGS. 4 to 6, in an embodiment of the present application, there are two first connecting ears 114, two second connecting ears 132, two rotating shafts 17, and two second elastic members 19. The two first connecting ears 114 are spaced apart along the axial direction of the rotating shaft 17, forming a wire passage 115 between them. Each second connecting ear 132 corresponds to one first connecting ear 114 and is located outside the wire passage 115. Each rotating shaft 17 passes through one second connecting ear 132 and one first connecting ear 114, and each second elastic member 19 is sleeved onto one rotating shaft 17.

In this embodiment, the number of the first connecting ear 114, the second connecting ear 132, the rotating shaft 17, and the second elastic member 19 are all set to two. This improves the stability of the connection between the first connecting member 11 and the second connecting member 13, and enhances the damping effect on the second connecting member 13 when folding or rotating from the folded position to the open position. Furthermore, a wire passage 115 is formed between the two first connecting ears 114. This allows the signal wire to pass through easily, facilitating signal transmission between the temple 50 and the front frame. Simultaneously, passing the signal wire through the middle of the hinge module 10 reduces the length variation of the signal wire during the rotation of the hinge module 10, thus reducing the risk of signal wire bending. In addition, this arrangement saves space in the thickness direction of the hinge module 10, which is more advantageous for the overall thickness dimension design of the temple 50, while also reducing the weight of the hinge module 10.

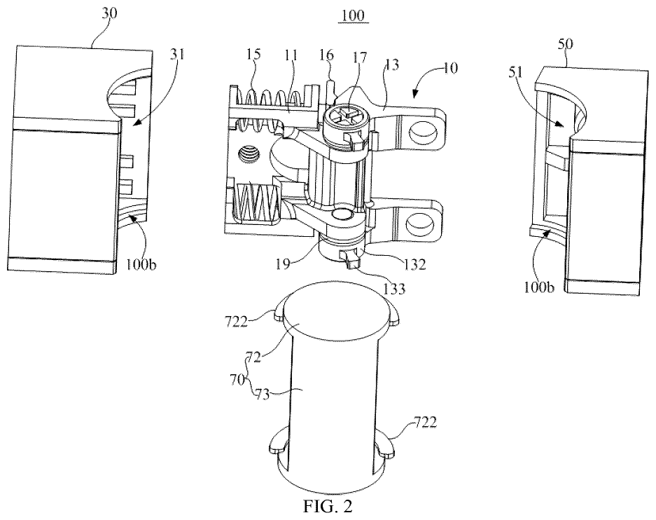

Referring to FIGS. 1 and 2, the present application also proposes smart glasses 100, which includes a frame 30, temples 50, and a hinge module 10. The specific structure of the hinge module 10 is as claimed in the above embodiments. Since the present application adopts all the technical solutions of all the above embodiments, it possesses at least all the beneficial effects brought about by the technical solutions of the above embodiments, and will not be elaborated further here. Specifically, the first connecting member 11 in the hinge module 10 is connected to the frame 30, and the second connecting member 13 in the hinge module 10 is connected to the temples 50.

Referring to FIGS. 1 and 2, in an embodiment of the present application, the smart glasses 100 further includes a shaft cover 70, which is circularly projected along the axis of the rotating shaft 17. The shaft cover 70, the frame 30, and the temples 50 enclose an accommodating space 100a, within which the hinge module 10 is located.

In this embodiment, the hinge module 10 is arranged within an accommodating space 100a formed by the shaft cover 70, the frame 30, and the temple 50. This allows the hinge module 10 to be concealed, thereby improving its protection and enhancing the aesthetics of the smart glasses 100, thus increasing its market competitiveness. To simplify the structure of the accommodating space 100a, a first groove 31 can be provided at the frame 30, a second groove 51 can be provided at the second connecting member 13, and a third groove 71 can be provided at the shaft cover 70. The first groove 31, the second groove 51, and the third groove 71 are enclosed to form the accommodating space 100a. Part of the first connecting member 11 can be installed within the first groove 31, and part of the second connecting member 13 can be installed within the second groove 51. The surfaces of the first and second connecting members 11 and 13 that abut against the shaft cover 70 can be rounded to allow the temple 50 to rotate about the axis of the shaft cover 70.

Referring to FIGS. 1 and 2, in an embodiment of the present application, the shaft cover 70 includes two end plates 72 and a connecting plate 73. The two end plates 72 are located on opposite sides of the hinge module 10 along the axial direction of the rotating shaft of the shaft 17, and are coaxially arranged with the rotating shaft of the first connecting member 11 and the second connecting member 13. The two opposite ends of the connecting plate 73 are connected to the two end plates 72. At least one end plate 72 and/or the connecting plate 73 has two first limiting ribs 74 on its inner side, spaced apart circumferentially along the end plate 72. The second connecting member 13 has a second limiting rib 133 located between the two first limiting ribs 74.

In this embodiment, by including two end plates 72 and a connecting plate 73 in the shaft cover 70, the side circumferential surface of the shaft cover 70 is not closed, thus facilitating the avoidance of portions of the first connecting member 11, the second connecting member 13, and the signal lines passing through the wire passage 115 as described above. The two end plates 72 and the connecting plate 73 are enclosed to form the third groove 71 described above. Furthermore, in the open state, the connecting plate 73 can be located inside the shaft cover 70. Further, the two first limiting ribs 74 and the second limiting rib 133 allow the second connecting member 13 to rotate, thereby driving the shaft cover 70 to rotate. This provides better concealment of the internal structure through the shaft cover 70 in the folded, open, and outward-folding states, further improving the aesthetics of the smart glasses 100 and enhancing the user experience. The first limiting rib 74 can be connected to only one end plate 72 or both end plates 72, or only to the connecting plate 73, or simultaneously to both end plates 72 and the connecting plate 73; the second limiting rib 133 can be located on the second connecting ear 132 of the second connecting member 13.

Referring to FIGS. 1 and 2, in an embodiment of the present application, the second connecting ear 132 of the second connecting member 13 may have a protruding circular boss 134. The boss 134 and the rotating shaft 17 are coaxially arranged. An insertion hole 721 may be provided at the end plate 72, and the boss 134 is inserted into the insertion hole 721 to achieve a rotational fit between the shaft cover 70 and the second connecting member 13, improving the stability of the installation.

Referring to FIGS. 1 and 2, in an embodiment of the present application, a flange 722 may be protruding on the outer side of the end plate 72. The flange 722 extends circumferentially along the end plate 72. A groove 100b may be provided at the inner side of the frame 30 and the temple 50, and the flange 722 is accommodated within the groove 100b to ensure a circumferential end difference between the end plate 72 and the frame 30 and the temple 50, and to further improve the stability of the connection between the shaft cover 70, the frame 30, and the temple 50. The groove 100b on the frame 30 can be provided at the groove wall of the first groove 31 described above, and the groove 100b on the temple 50 can be provided at the groove wall of the second groove 51 described above.

Although some embodiments of the present application have been described, those skilled in the art, upon learning the basic inventive concept, can make other changes and modifications to these embodiments. Therefore, the appended claims are intended to be interpreted as including the embodiments as well as all changes and modifications falling within the scope of the present application.

The above descriptions are only some embodiments of the present application, and does not limit the patent scope of the present application. All equivalent structural transformations made by using the contents of the present application specification and drawings under the technical concept of the present application, or directly/indirectly applied in other related technical fields, are included in the patent protection scope of the present application.

What is claimed is:

1. A hinge module, comprising:
a first connecting member;
a second connecting member rotatably connected to the first connecting member via a rotating shaft, wherein the second connecting member has an open state, and the second connecting member in the open state is capable of rotating and folding in a first direction and rotating and folding outward in a second direction opposite to the first direction; and
a first elastic member configured to apply a damping elastic force to the rotating and outward-folding second connecting member, and a direction of the elastic force of the first elastic member intersects an axial direction of the rotating shaft.

2. The hinge module as claimed in claim 1, wherein the first elastic member is provided at the first connecting member, and the hinge module further comprises a sliding member; the sliding member is slidably connected to the first connecting member, and the rotating and outward-folding second connecting member is capable of abutting and driving the sliding member to press against the first elastic member.

3. The hinge module as claimed in claim 2, wherein the sliding member comprises:
a sliding rod slidably connected to the first connecting member, and the rotating and outward-folding second connecting member being capable of abutting and driving the sliding rod; and
a driving plate connected to the sliding rod and abutted against the first elastic member.

4. The hinge module as claimed in claim 3, wherein the first connecting member is provided with a mounting groove and a through hole communicating with the mounting groove, and the first elastic member is provided within the mounting groove; the sliding rod passes through the through hole, and the driving plate is provided within the mounting groove.

5. The hinge module as claimed in claim 4, wherein the first elastic member and the driving plate are sleeved on the sliding rod located within the mounting groove; and/or
the first connecting member is further provided with a mounting opening communicating with the through hole and an outer surface of the first connecting member.

6. The hinge module as claimed in claim 4, wherein the sliding member further comprises an abutting plate connected to the sliding rod and located on a side of the driving plate opposite to the first elastic member, and the rotating and outward-folding second connecting member is abutted against and drives the abutting plate.

7. The hinge module as claimed in claim 6, wherein the second connecting member is provided with a driving surface, and the abutting plate is provided with an abutting surface on a side opposite to the driving plate; the rotating and outward-folding second connecting member is abutted against the abutting surface through the driving surface, and both the driving surface and the abutting surface comprise an outwardly convex arc surface; and/or
the abutting plate extends along the axial direction of the rotating shaft, and a number of the sliding rod, the driving plate, and the first elastic member is at least two respectively; at least two of the sliding rods are connected to the abutting plate and are arranged sequentially along the axial direction of the rotating shaft; each driving plate is connected to one sliding rod, and each first elastic member is abutted against one driving plate.

8. The hinge module as claimed in claim 1, wherein the first connecting member is provided with a first connecting ear, and the second connecting member is provided with a second connecting ear; the second connecting ear and the first connecting ear is arranged opposite to each other; and
the hinge module further comprises a rotating shaft and a second elastic member, and the rotating shaft passes through the first connecting ear and the second connecting ear; the second elastic member is sleeved on the rotating shaft and elastically abutted against the first connecting ear and the second connecting ear.

9. The hinge module as claimed in claim 8, wherein a number of the first connecting ear, the second connecting ear, the rotating shaft, and the second elastic member are all two; the two first connecting ears are spaced apart in the axial direction of the rotating shaft, and a wire passage is formed between the two first connecting ears; and
each second connecting ear corresponds to one first connecting ear and is located outside the wire passage; each rotating shaft passes through one second connecting ear and one first connecting ear, and each second elastic member is sleeved on one rotating shaft.

10. Smart glasses, comprising: a frame, temples, and the hinge module as claimed in claim 1, wherein a first connecting member in the hinge module is connected to the frame, and a second connecting member in the hinge module is connected to the temples.

11. The smart glasses as claimed in claim 10, wherein the smart glasses further comprise a shaft cover, and the shaft cover is circular in projection along the axial direction of the rotating shaft; and
the shaft cover, the frame, and the temples are enclosed to form an accommodating space, and the hinge module is located within the accommodating space.

12. The smart glasses as claimed in claim 11, wherein the shaft cover comprises:
two end plates located on opposite sides of the hinge module in the axial direction of the rotating shaft and coaxially arranged with the rotating shaft; and
a connecting plate, opposite ends of the connecting plate being connected to the two end plates;
wherein at least one end plate and/or the connecting plate is provided with two first limiting ribs on an inner side, and the two first limiting ribs are spaced apart circumferentially along the end plate; the second connecting member is provided with a second limiting rib, and the second limiting rib is located between the two first limiting ribs.
